(19) United States
(12) Patent Application Publication
(10) Pub. No.: US 2015/0172788 A1
(43) Pub. Date: Jun. 18, 2015

(54) Wireless Connective Apparatus

(71) Applicant: Matatakitoyo Tool Co., Ltd., Taichung City (TW)

(72) Inventor: Yi Min Wu, TAICHUNG (TW)

(21) Appl. No.: 14/251,571

(22) Filed: Apr. 12, 2014

(30) Foreign Application Priority Data
Dec. 17, 2013 (TW) 102223746

(51) Int. Cl. H04Q 9/00

(52) U.S. Cl. CPC H04Q 9/00

(57) ABSTRACT

A wireless connective apparatus includes a connective rod, a transmission unit and a reception unit. The transmission unit includes a sensor for detecting a change in the status of the connective rod and a wireless transmitter for transmitting a wireless signal based on the change. The reception unit includes a wireless receiver for receiving the wireless signal from the wireless transmitter and a display for showing the change based on the wireless signal.

### BACKGROUND OF INVENTION

1. Field of Invention

The present invention relates to a connective rod for a tool and, more particularly, to a wireless connective apparatus.

2. Related Prior Art

A ratchet wrench includes a handle and a set of bits. The set of bits include sockets and/or screwdrivers. A selected one of the bits is connected to the handle at a time. The selected bit is engaged with a nut or a head of a screw before the handle is operated to exert a torque on the nut or the screw. If the torque is insufficient, the nut or the screw may be loose, and so be a part of a machine on which the nut or screw is used. If the torque is excessive, the nut or the screw may be damaged, and so be the part of the machine.

To overcome the above-mentioned problem, the ratchet wrench can be provided with a connective rod and a sensor. The connective rod is used to connect a bit to the handle. The sensor is used to detect and display a torque exerted on the connective rod and/or an angle of rotation of the connective rod. However, the torque and/or the angle are not observable when the sensor is hidden behind the connective rod or a machine because the sensor is movable together with the connective rod.

Therefore, the present invention is intended to obviate or at least alleviate the problems encountered in prior art.

### SUMMARY OF INVENTION

It is the primary objective of the present invention to provide a wireless connective apparatus.

To achieve the foregoing objective, the wireless connective apparatus includes a connective rod, a transmission unit and a reception unit. The transmission unit includes a sensor for detecting a change in the status of the connective rod and a wireless transmitter for transmitting a wireless signal based on the change. The reception unit includes a wireless receiver for receiving the wireless signal from the wireless transmitter and a display for showing the change based on the wireless signal.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is an exploded view of a wireless connective apparatus in accordance with the first embodiment of the present invention;

FIG. 2 is a perspective view of the wireless connective apparatus shown in FIG. 1;

FIG. 3 is a block diagram of the wireless connective apparatus shown in FIG. 2; and

FIG. 4 is a perspective view of a wireless connective apparatus in accordance with the second embodiment of the present invention.

### DETAILED DESCRIPTION OF PREFERRED EMBODIMENT

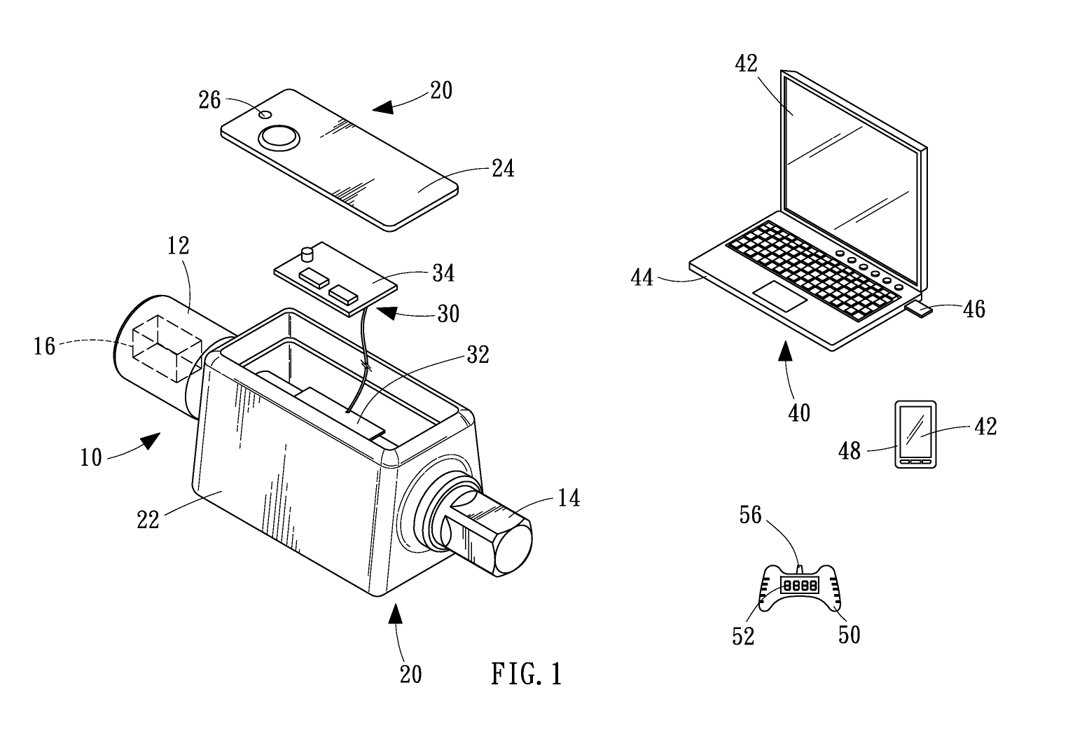

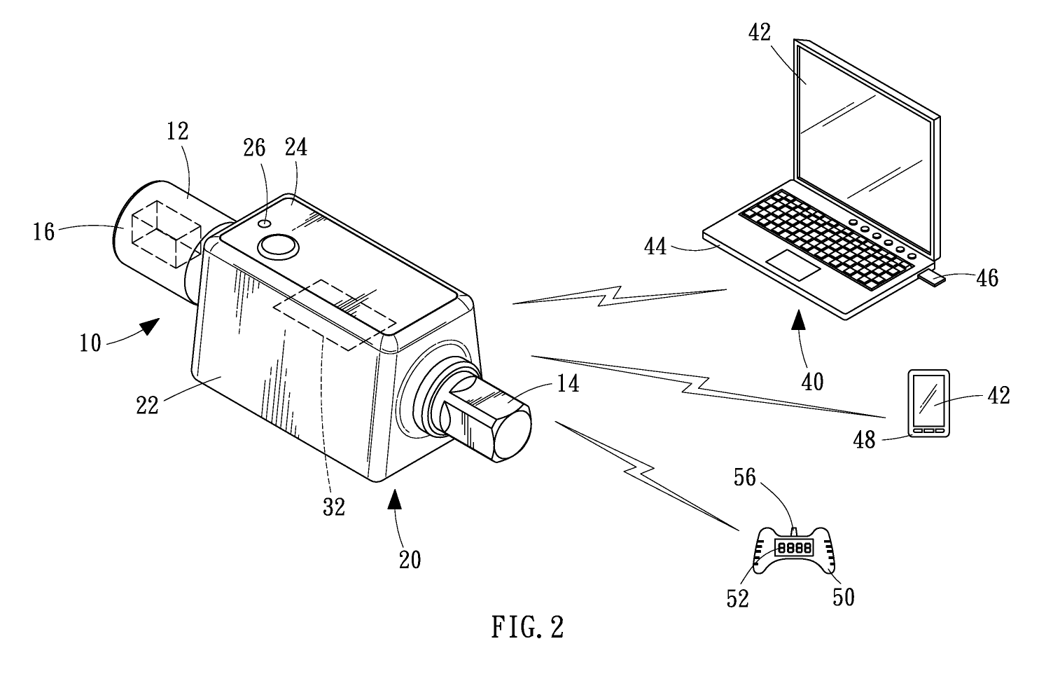

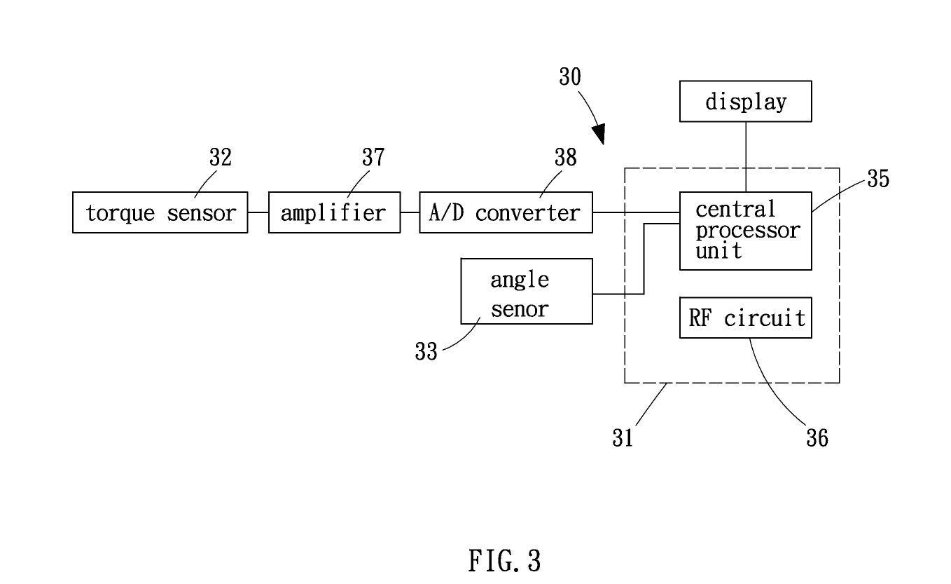

Referring to FIGS. 1 to 3, a wireless connective apparatus includes a connective rod 10, a transmission unit 30 and a reception unit 40 according to a first embodiment of the present invention. The connective rod 10 includes an input section 12 and an output section 14. The input section 12 includes a polygonal bore 16 for receiving a compliant tongue extending from a handle or an electric or pneumatic tool. The output section 14 includes a square tongue (not numbered) for insertion in a compliant bore made in a socket (not shown) for example. A torque can be exerted on the socket from the handle or electric or pneumatic tool via the connective rod 10.

A middle section of the connective rod 10 is inserted in a shell 20 while the input section 12 and the output section 14 are placed out of the shell 20. The shell 20 includes a box 22 and a cover 24. The cover 24 includes an aperture 26. A light such as an LED (not numbered) or a button (not numbered) of the transmission 30 can be inserted in the aperture 26.

The transmission unit 30 is placed in the shell 20. The transmission unit 30 includes a set of sensors and a circuit board 34. The set of sensors includes a torque sensor 32 and an angle sensor 33 at least. The torque sensor 32 can be a strain gauge attached to the connective rod 10 to detect the torque exerted on the connective rod 10. The angle sensor can be a photo interrupter, an encoder, a gyroscope or a magnetic sensor attached to the connective rod 10 to detect an angle of rotation of the connective rod 10.

A photo interrupter includes an optical receiver for receiving an optical signal from an optical emitter. Then, the optical receiver converts the optical signal into a digital signal.

An encoder detects the angle of the rotation of the connective rod 10. Then, the encoder provides an electric pulse-based signal according to the angle of the rotation of the connective rod 10.

A gyroscope detects the speed of the rotation of the connective rod 10. Then, the gyroscope provides an electric signal according to the angle of the rotation of the connective rod 10.

The circuit board 34 includes a wireless transmitter 31, an amplifier 37 and an A/D converter 38. The wireless transmitter 31 includes a central processor unit (“CPU”) 35 electrically connected to a radio frequency (“RF”) circuit 36. The torque sensor 32 is electrically connected to the amplifier 37. The amplifier 37 is electrically connected to the A/D converter 38. The A/D converter 38 is electrically connected to the CPU 35. The angle sensor 33 is electrically connected to the CPU 35.

The reception unit 40 includes a personal computer (“PC”) 44 equipped with a wireless receiver 46. The PC 44 includes a display 42 such as a liquid crystal display. The wireless receiver 46 and the PC 44 are made separately and then connected to in the first embodiment. The wireless receiver 46 can however be built in the PC 44 in another embodiment.

The reception unit 40 includes an additional cell phone 48. The cell phone 48 is used to communicate with the PC 44 and/or the transmission unit 30.

The reception unit 40 includes an additional a controller 50. The controller 50 is used to communicate with the PC 44 and/or the transmission unit 30 in a wireless manner. To this end, the controller 50 includes a wireless transceiver 56. The controller 50 further includes a display 52.

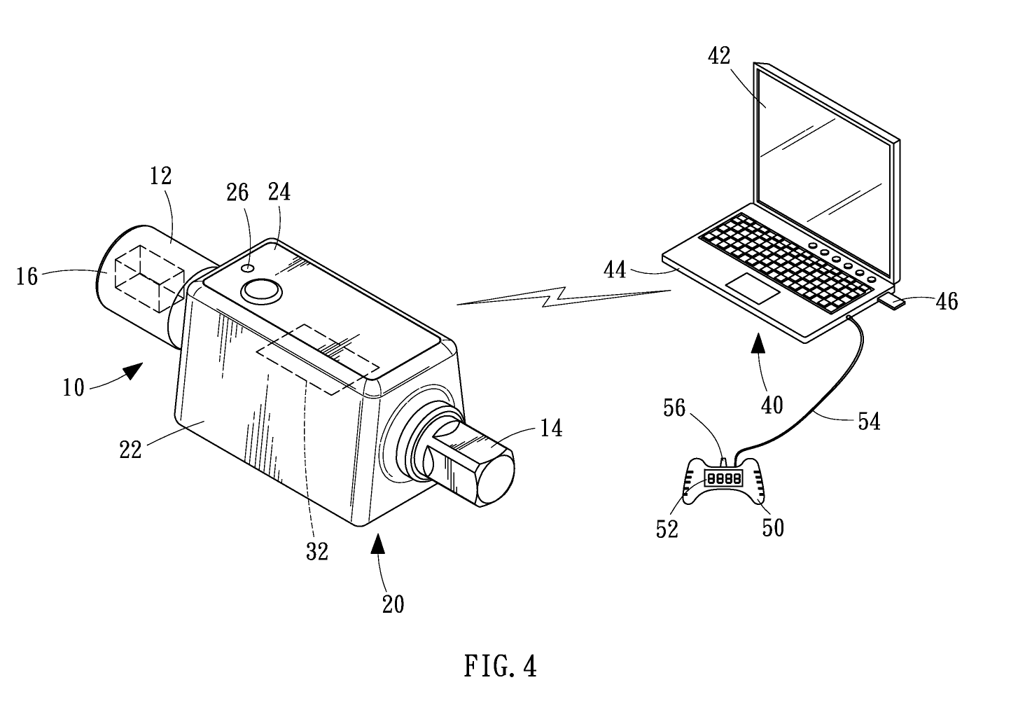

Referring to FIG. 4, there is a wireless connective apparatus in accordance with a second embodiment of the present invention. The second embodiment is identical the first embodiment except that the controller 50 can be connected to the reception unit 40 via a cable 54.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A wireless connective apparatus including:
a connective rod;
a transmission unit including a sensor for detecting a change in the status of the connective rod and a wireless transmitter for transmitting a wireless signal based on the change; and
a reception unit including a wireless receiver for receiving the wireless signal from the wireless transmitter and a display for showing the change based on the wireless signal.

2. The wireless connective apparatus according to claim 1, further including a shell for covering the transmission unit.

3. The wireless connective apparatus according to claim 2, wherein the shell covers the connective rod except an input section and an output section.

4. The wireless connective apparatus according to claim 1, wherein the sensor is selected from the group consisting of a photo interrupter, a strain gauge, an encoder and a gyroscope.

5. The wireless connective apparatus according to claim 1, wherein the display is included in a device selected from the group consisting of a cell phone, a computer and a remote controller.
